(19) United States
(12) Patent Application Publication
(10) Pub. No.: US 2012/0132771 A1
(43) Pub. Date: May 31, 2012

(54) ADJUSTABLE SUPPORT APPARATUS

(76) Inventor: Charlie WANG, Taipei (TW)

(21) Appl. No.: 13/215,808

(22) Filed: Aug. 23, 2011

(30) Foreign Application Priority Data
Nov. 26, 2010 (TW) 099141035
Nov. 26, 2010 (TW) 099223012

(51) Int. Cl. F16M 13/02

(52) U.S. Cl. 248/278.1; 248/276.1

(57) ABSTRACT

The present invention relates to an adjustable support apparatus comprising a support rod, a chassis, and a connecting seat. The two ends of the support rod are provided with the chassis and the connecting seat via a U-type connecting unit, and the hollow rod of the support rod is able to cover a linked device. This is achieved to maintain a fixed angle between the connecting seat and the chassis by using the linked device when users adjust the position of the connecting seat. Because of the assembly of the U-type connecting unit, interference from each unit can be avoided, and the adjustable range and angle of the support rod and the connecting seat can be increased, and furthermore to balance the force on both sides of the U-type connecting unit and improve the construction of the support apparatus.

### BACKGROUND OF THE INVENTION

1. Technical Field

The present invention generally relates to an adjustable support apparatus. Through assembly of the U-type connecting unit, the interference of each unit on the support apparatus can be avoided, and the adjustable range and angle of the support rod and the connecting seat can thereby be increased.

2. Description of the Prior Art

Referring to FIG. 1, shown is an exploded diagram of a support apparatus according to the prior art. The support apparatus 10 comprises a chassis 11, a hang arm 13, a connecting rod 15, and a front arm 17. The two ends of the hang arm 13 and the connecting rod 15 respectively connect with the chassis 11 and the front arm 17. Moreover, the chassis 11 is able to be disposed on a fixture, and the front arm 17 is able to bear a monitor 19.

The hang arm 13 is a connecting rod with two side walls. Both lower ends of the side walls of the hang arm 13 are provided with a first axle bolt 111 so as to be assembled to the chassis 11. The lower end of the hang arm 13 forms a rotatable joint with the chassis 11 by the first axle bolt 111. Both upper ends of the side walls of the hang arm 13 are provided with a second axle bolt 171 so as to be assembled to the front arm 17. The upper end of the hang arm 13 forms a rotatable joint with the front arm 17 by the second axle bolt 171.

Both upper ends of the hang arm 13 are respectively provided with arc slots 131. A third axle bolt 173 is disposed through the arc slots 131, so as to fix the hang arm 13 to the front arm 17.

Connecting rod 15 connects with the hang arm 13, and the lower ends of both side walls of the connecting rod 15 are respectively provided with axle holes 151. A fourth axle bolt 113 is disposed through the axle holes 151 of the connecting rod 15 onto the chassis 11, to fix the connecting rod 15 to the chassis 11. Therefore, the lower end of the connecting rod 15 forms a rotatable joint with the chassis 11 by way of the fourth axle bolt 113. Both lower ends of the side walls of the connecting rod 15 are respectively provided with arc slots 153. The first axle bolt 111 is disposed through the arc slots 153. Moreover, a third axle bolt 173 is disposed through both upper ends of the side walls of the connecting rod 15 onto the front arm 17, so that both upper ends of the side walls of the connecting rod 15 form a rotatable joint with the front arm 17.

A spring 12 is a coil-type spring sleeved onto the first axle bolt 111. One end of the spring 12 is disposed against the connecting rod 15, and the other end of the spring 12 is disposed against the fourth axle bolt 113, so as to provide an appropriate upward reaction force to the connecting rod 15.

Furthermore, the diameter of the axle hole 151 is larger than the diameter of the fourth axle bolt 113 disposed within the axle hole 151, that is, there is a space formed between the axle hole 151 and the fourth axle bolt 113. When the connecting rod 15 is lifted up slightly, the arc edges 155, formed at the rear edges of the lower ends of both side walls of the connecting rod 15, will disengage from the stop bolt 14. Then, the hang arm 13 and the connecting rod 15 can be moved smoothly, so as to adjust the position of the monitor 19.

Referring to FIG. 2A and FIG. 2B, shown are cross-sectional views of a support apparatus according to the prior art during operation. The support apparatus 10 is capable of adjusting the position of the monitor 19. For instance, a user operates the support apparatus 10 to adjust the monitor 19 to a higher position, as shown in FIG. 2A, or a lower position, as shown in FIG. 2B. There is an overlap region 161/163 formed between the hang arm 13 and the connecting rod 15, as the dotted line indicates in FIG. 2A and FIG. 2B. Moreover, the area of the overlap region 161/163 and the size of the hang arm 13 and the connecting rod 15 will be changed, as the monitor 19 on the support apparatus 10 is adjusted to a higher position or lower position. For example, the area of the overlap 161 of FIG. 2A is larger that the overlap 163 of FIG. 2B.

It is not conducive to the operation of the support apparatus 10 with various sizes of the overlap 161/163, the hang arm 13, and the connecting rod 15. Furthermore, a user's fingers may be clipped between the hang arm 13 and the connecting rod 15 during operation or adjustment of the support apparatus 10.

### SUMMARY OF THE INVENTION

It is a feature of the present invention to provide an adjustable support apparatus, wherein the two ends of a support rod of the support apparatus are respectively connected to a chassis and a connecting seat. Moreover, the support rod comprises a hollow column to cover a linked device for maintaining the size of the support apparatus and avoid users' fingers being clipped by the hang arm and the connecting rod in accordance to the prior art.

It is another feature of the present invention to provide an adjustable support apparatus, wherein the two ends of the support rod are respectively provided with a U-type connecting unit to connect with the chassis and the connecting seat. Because of the U-type connecting unit assembly, interference from each unit can be avoided, and the adjustable range and angle of the support rod and the connecting seat can be increased, and firthennore the force exerted on both sides of the U-type connecting unit can be balanced and the construction of the support apparatus improved upon.

It is still another feature of the present invention to provide an adjustable support apparatus, which is capable of holding the position of the connecting seat via friction among the rod, the connecting device, the chassis, and the connecting seat, thus allowing the user to adjust the support apparatus more easily.

It is still another feature of the present invention to provide an adjustable support apparatus, wherein the linked device is inside the hollow rod in order to avoid causing accidents during operation of the support apparatus.

It is still another feature of the present invention to provide an adjustable support apparatus, wherein the linked device within the rod comprises a linked rod and a spring unit. The spring unit is sleeved onto the linked rod, and the two ends of the linked rod are respectively provided with a washer. The spring unit disposed between the first washer and the second washer can be compressed or extended during operation of the support apparatus, and the spring force of the spring unit is able to support the weight and hold the position of the connecting seat.

It is still another feature of the present invention to provide an adjustable support apparatus, wherein the two ends of the support rod are respectively connected to the chassis and the connecting seat. The connecting seat is capable of adjusting the position and the angle of the monitor thereon and maintaining a fixed angle between the chassis and the connecting seat.

It is still another feature of the present invention to provide an adjustable support apparatus, wherein the chassis is inserted into a fixture, and rotated relative to the fixture to improve upon the convenience of operating the support apparatus.

To achieve these and other objects of the present invention, the present invention provides an adjustable support apparatus, comprising: a support rod, comprising: a rod comprising a hollow column, wherein two ends of the hollow column are respectively provided with at least one first connecting part and at least one second connecting part; and a linked device comprising a linked rod disposed within the hollow column, wherein two ends of the linked rod are respectively connected to a first connecting unit and a second connecting unit; a chassis comprising at least one wing connected to the first connecting unit of the linked device, wherein the wing of the chassis is connected to the first connecting part of the rod via a first U-type connecting unit; and a connecting seat comprising at least one connecting piece connected to the second connecting unit of the linked device, wherein the connecting piece of the connecting seat is connected to the second connecting part of the rod via a second U-type connecting unit.

In one embodiment of aforesaid adjustable support apparatus, wherein the first U-type connecting unit and the second U-type connecting unit both comprise a bottom plate and two side plates set on two opposite sides of the bottom plate.

In one embodiment of aforesaid adjustable support apparatus, comprising two first fixed units respectively disposed on the two side plates of the first U-type connecting unit to connect the first connecting part, the wing and the first U-type connecting unit, and two second fixed units respectively disposed on the two side plates of the second U-type connecting unit to connect the second connecting part, the connecting piece, and the second U-type connecting unit.

In one embodiment of aforesaid adjustable support apparatus, further comprising at least one first fillister positioned on the two side plates of the first U-type connecting unit, and at least one second fillister positioned on the two side plates of the second U-type connecting unit.

In one embodiment of aforesaid adjustable support apparatus, further comprising a first bolt connecting the first connecting unit, the first connecting part, and the chassis, and a second bolt connecting the second connecting unit, the second connecting part, and the connecting seat.

In one embodiment of aforesaid adjustable support apparatus, wherein the first bolt is retained within the first fillister, and the second bolt is retained within the second fillister.

In one embodiment of aforesaid adjustable support apparatus, further comprising a first arc slot positioned on the first connecting part for containing the first bolt, and a second arc slot positioned on the second connecting part for containing the second bolt.

In one embodiment of aforesaid adjustable support apparatus, wherein the chassis and the rod are able to rotate relative to the two first fixed units, and the rod and the connecting seat are able to rotate relative to the two second fixed units.

In one embodiment of aforesaid adjustable support apparatus, further comprising a spring device disposed on the linked rod.

In one embodiment of aforesaid adjustable support apparatus, wherein the spring device comprises a spring unit, a first washer, and a second washer, wherein the spring unit is sleeved onto the linked rod, the two ends of the rod are respectively connected to the first washer and the second washer, and the spring unit is disposed between the first washer and the second washer.

In one embodiment of aforesaid adjustable support apparatus, wherein the support rod comprises a first support rod and a second support rod.

In one embodiment of aforesaid adjustable support apparatus, further comprising a connecting unit for connecting the first support rod and the second support rod.

To achieve these and other objects of the present invention, the present invention provides another adjustable support apparatus, comprising: a support rod, comprising: a rod comprising a hollow column, wherein the two ends of the hollow column are respectively provided with at least one first connecting part and at least one connecting part; and a linked device comprising a linked rod positioned within the hollow column, wherein the two ends of the linked rod are respectively connected to a first connecting unit and a second connecting unit; a chassis comprising at least one wing connected to the first connecting unit of the linked device, wherein the wing of the chassis is connected to the first connecting part of the rod via a first axle bolt; and a connecting seat comprising at least one connecting piece connected to the second connecting unit of the linked device, wherein the connecting piece of the connecting seat is connected to the second connecting part of the rod via a second axle bolt.

In one embodiment of aforesaid adjustable support apparatus, further comprising a first bolt connecting the first connecting unit, the first connecting part, and the chassis, and a second bolt connecting the second connecting unit, the second connecting part, and the connecting seat.

In one embodiment of aforesaid adjustable support apparatus, further comprising a spring device positioned on the linked rod.

In one embodiment of aforesaid adjustable support apparatus, wherein the spring device comprises a spring unit, a first washer, and a second washer, wherein the spring unit is sleeved onto the linked rod, the two ends of the rod are respectively connected to the first washer and the second washer, and the spring unit is disposed between the first washer and the second washer.

In one embodiment of aforesaid adjustable support apparatus, further comprising comprises a first U-type connecting unit to connect the wing of the chassis and the first connecting part of the rod.

In one embodiment of aforesaid adjustable support apparatus, further comprising comprises a second U-type connecting unit to connect the connecting piece of the connecting seat and the second connecting part of the rod.

The present invention can be best understood through the following description and accompanying drawings.

### BRIEF DESCRIPTION OF THE DRAWINGS

FIG. 1 is an exploded diagram of a support apparatus according to the prior art;

FIG. 2A and FIG. 2B are cross-sectional views of a support apparatus according to the prior art during operation;

FIG. 3 is an exploded diagram of a support apparatus according to an embodiment of the present invention;

FIG. 3A and FIG. 3B are exploded diagrams of a support apparatus according to another embodiment of the present invention;

FIG. 4A and FIG. 4B are perspective diagrams of the support apparatus according to an embodiment of the present invention during operation;

FIG. 5A and FIG. 5B are structural diagrams of the support apparatus according to an embodiment of the present invention during operation;

FIG. 6 is an exploded diagram of a support apparatus according to another embodiment of the present invention; and

FIG. 7A and FIG. 7B are structural diagrams of the support apparatus according to another embodiment of the present invention.

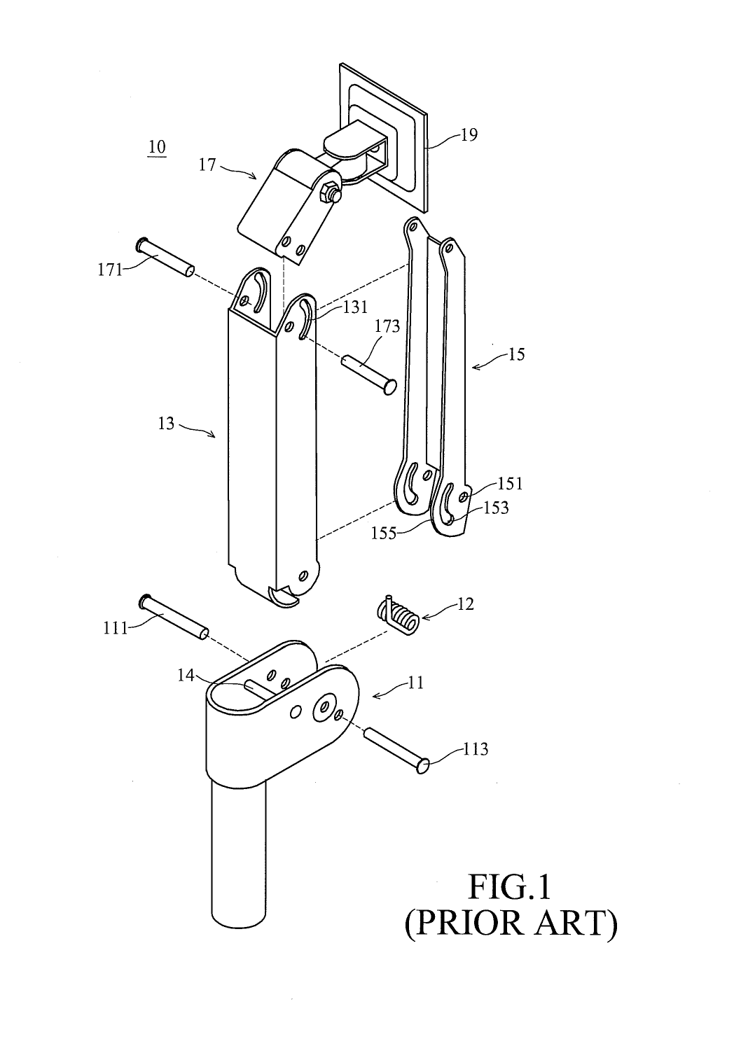

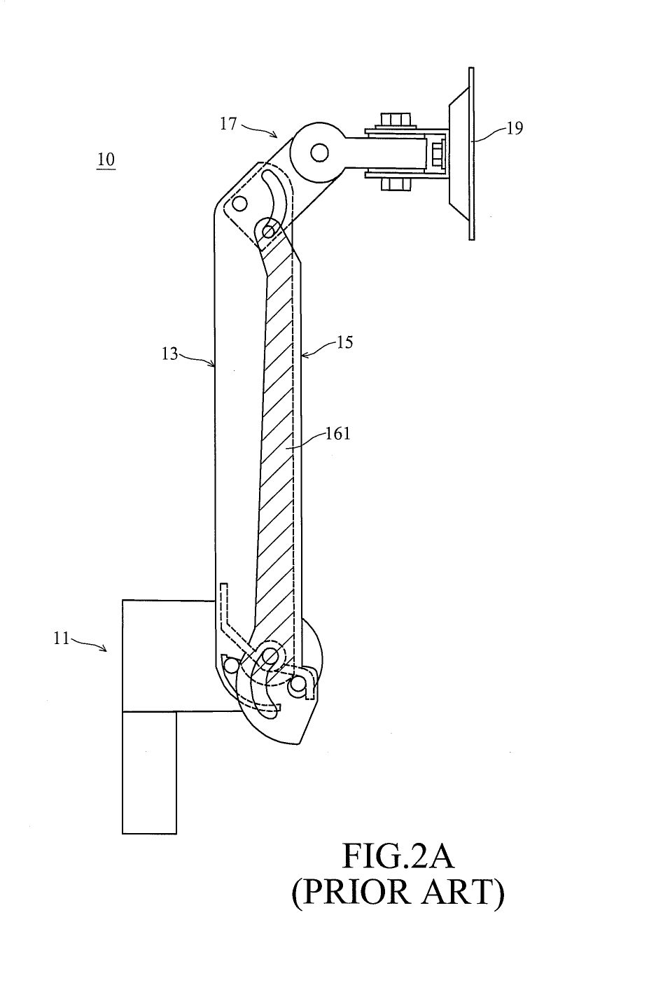

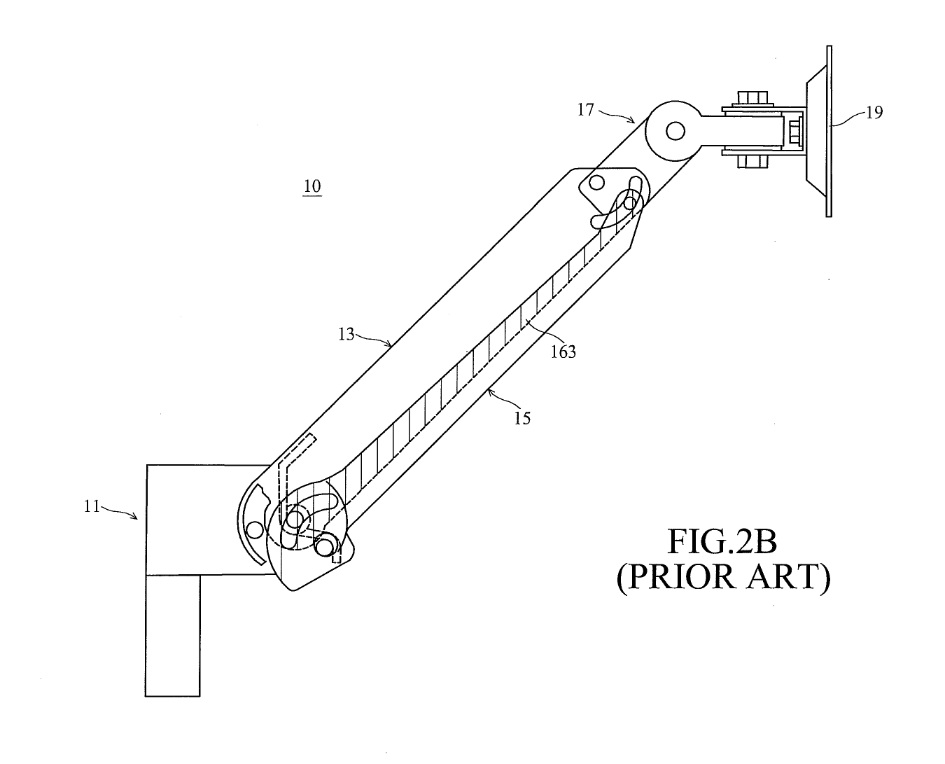

### DETAILED DESCRIPTION OF THE PREFERRED EMBODIMENTS

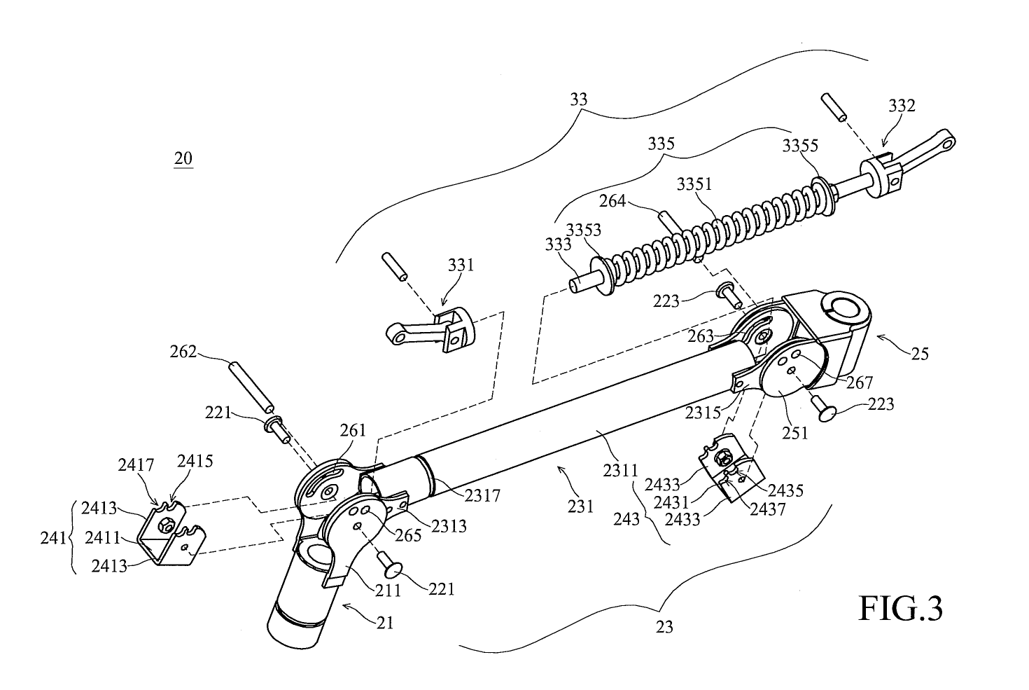

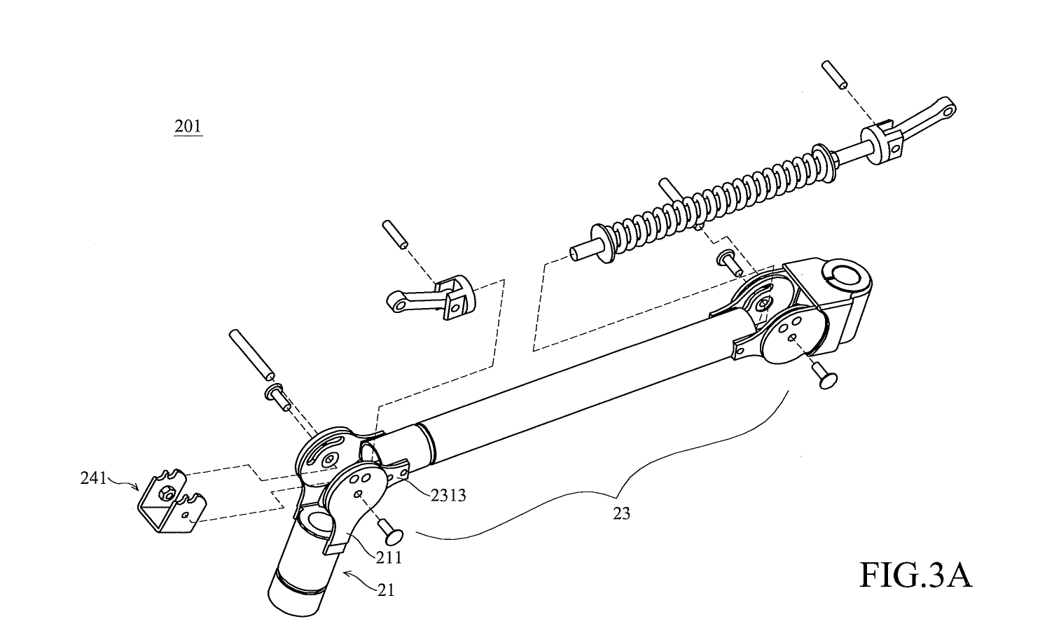

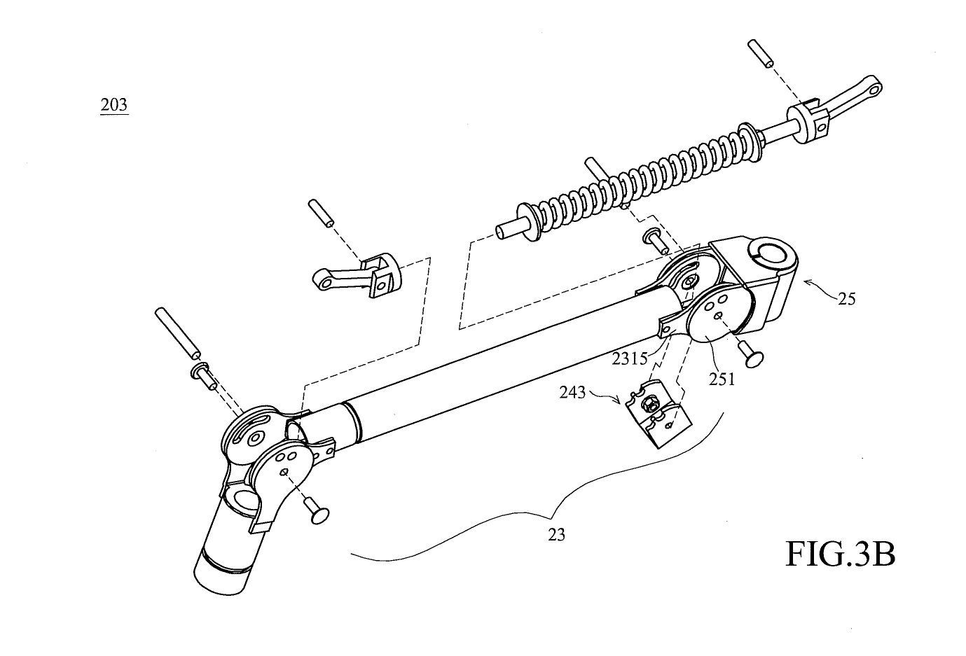

Referring to FIG. 3, shown is an exploded diagram of a support apparatus according to an embodiment of the present invention. The support apparatus 20 comprises a chassis 21, a support rod 23, and a connecting seat 25. The chassis 21 can be inserted into a fixture (not shown), and be horizontally rotated relative to the fixture. The connecting seat 25 is able to bear an object (not shown), such as a monitor, and adjust the position of the borne object.

The support rod 23 comprises a rod 231 and a linked device 33, and the rod 231 comprises a hollow column 2311. The two ends of the hollow column 2311 are respectively provided with at least one first connecting part 2313 and at least one second connecting part 2315, and the linked device 33 is disposed within the inside of the hollow column 2311.

The chassis 21 comprises at least one wing 211, such as two wings 211, connected to the first connecting part 2313 of the rod 231 via a first U-type connecting unit 241. For example, there are two first connecting parts 2313 to connect to the two wings 211, respectively.

In one embodiment of the invention, the first U-type connecting unit 241 comprises a bottom plate 2411 and two side plates 2413 set on two opposing sides of the bottom plate 2411 in order to from a U-shape connecting unit. The first connecting part 2313 of the rod 231 and the wing 211 of the chassis 21 overlap, and the first U-type connecting unit 241 is inserted between two first connecting parts 2313 and/or two wings 211. Thereafter, two first fixed units 221, such as screws or nuts, are respectively fixed to the two side plates 2413 of the first U-type connecting unit 241 to connect the first connecting part 2313, the wing 211, and the first U-type connecting unit 241.

The chassis 21 and the rod 231 can be connected to each other by way of the first U-type connecting unit 241 and the two first fixed units 221, and the rod 231 forms a rotatable joint with the chassis 21 by way of the first fixed units 221. Moreover, the two side plates 2413 of the first U-type connecting unit 241 are connected to each other via the opposite sides of the bottom plate 2411, so that the two first fixed units 221 are respectively able to stably lock onto the side plates 2413 to connect the rod 231 and the chassis 21, as the rod 231 and/or the chassis 21 are/is rotating.

The connecting seat 25 comprises at least one connecting piece 251, such as two connecting pieces 251, connected to the second connecting part 2315, such as two connecting parts 2315, of the rod 231 via a second U-type connecting unit 243. In one embodiment of the invention, the structure of the second U-type connecting unit 243 is similar to the first U-type connecting unit 241, and comprises a bottom plate 2431 and two side plates 2433. The second connecting part 2315 of the rod 231 and the connecting piece 251 of the connecting seat 25 overlap, and the second U-type connecting unit 243 is inserted between two second connecting parts 2315 and/or two connecting pieces 251. Thereafter, two second fixed units 223, such as screws or nuts, are respectively fixed to the two side plates 2433 of the second U-type connecting unit 243 in order to connect the second connecting part 2315, the connecting piece 251, and the second U-type connecting unit 243. The two second fixed units 223 are respectively able to stably lock onto the side plates 2433 to connect the rod 231 and the connecting seat 25, as the rod 231 and/or the connecting seat 25 are/is rotating.

The linked device 33 comprises a linked rod 333 positioned within the inside of the hollow column 2311, and the two ends of the linked rod 333 are respectively provided with a first connecting unit 331 and a second connecting unit 332. The linked rod 333 of the linked device 33 is positioned within the inside of the hollow column 2311, and a part of the first connecting unit 331 and the second connecting unit 332 is positioned outside of the hollow column 2311. In another embodiment of the invention, the connecting device 33 can also be a four-bar linkage or a parallel (Planar) four-bar linkage positioned within the hollow column 2311.

The first connecting unit 331 of the linked device 33 connects to the rod 231 and the chassis 21. For example, the first connecting unit 331 of the linked device 33 connects to the wing 211 of the chassis 21. In one embodiment of the invention, the first connecting part 2313 of the rod 231 is provided with at least one first arc slot 261, and the wing 211 of the chassis 21 is provided with at least one first through hole 265. Moreover, a first bolt 262 is capable of connecting the first connecting unit 331, the first connecting part 2313, and the chassis 21. For example, the first bolt 262 is disposed through the first hole 265 of the wing 211, the first arc slot 261 of the first connecting part 2313, and the first connecting unit 331. The first bolt 262 is retained within the first through hole 265, and is able to move along the first arc slot 261.

The first U-type connecting unit 241 is provided with at least one first fillister 2415. For example, there are two first fillisters 2415 disposed on the two side plates 2413 of the first U-type connecting unit 241 respectively, and the first bolt 262 is disposed through the wing 211, and the first connecting part 2313 and the first connecting unit 331 are retained within the first fillister 2415. As the support rod 23 is rotating, the first U-type connecting unit 241 rotates because of the first bolt 262, and will avoid looseness of the first fixed unit 221 locked onto the first U-type connecting unit 241. In another embodiment of the invention, the first U-type connecting unit 241 is provided with at least one third fillister 2417. For example, there are two third fillisters 2417 disposed on the two side plates 2413, and the first bolt 262 can be retained within the third fillister 2417.

The second connecting unit 332 of the linked device 33 is connected to the rod 231 and the connecting seat 25. For example, the second connecting unit 332 of the linked device 33 connects to the connecting piece 251 of the connecting seat 25. In one embodiment of the invention, the second connecting part 2315 of the rod 231 is provided with at least one second arc slot 263, and the connecting piece 251 of the connecting seat 25 is provided with at least one second through hole 267. Moreover, a second bolt 264 is capable of connecting the second connecting unit 332, the second connecting part 2315, and the connecting seat 25. For example, the second bolt 264 is disposed through the second hole 267 of the connecting piece 251, the second arc slot 263 of the second connecting part 2315, and the second connecting unit 332. The second bolt 264 is retained within the second through hole 267, and is able to move along the second arc slot 263.

The structure of the second U-type connecting unit 243 is similar to the first U-type connecting unit 241, and comprises at least one second fillister 2435. For example, there are two second fillisters 2435 disposed on the two side plates 2433 of the second U-type connecting unit 243 respectively, and the second bolt 264 disposed through the connecting piece 251, the second connecting part 2315, and the second connecting unit 332 is retained within the second fillister 2435. As the support rod 23 of the connecting seat 25 is rotating, the second U-type connecting unit 243 will rotate because of the second bolt 264, and will avoid looseness of the second fixed unit 223 locked onto the second U-type connecting unit 243. In another embodiment of the invention, the second U-type connecting unit 243 is provided with at least one fourth fillister 2437. For example, there are two fourth fillisters 2437, and the second bolt 264 can be retained within the fourth fillister 2437.

Because of the assembly of the first U-type connecting unit 241 and the second U-type connecting unit 243, interference from each unit of the support apparatus 20 can be avoided, and the adjustable range and angle of the support rod 23 and the connecting seat 25 can be increased. Furthermore, the first U-type connecting unit 241 is capable of balancing the force of the two first fixed units 221 fixed to both sides plates 2413, and the second U-type connecting unit 243 is capable of balancing the force on the two second fixed units 223 fixed to both sides plates 2433 to improve the construction of the support apparatus 20.

The rod 231 comprises an engagement unit 2317. For example, the inner surface of the hollow column 2311 is provided with a flange or bump. One end of the spring device 335, such as a first washer 3353, is lodged in the engagement unit 2317. As the support rod 23 rotates relative to the chassis 21 and/or the connecting seat 25, the chassis 21 and the connecting seat 25 can push or pull each other via the linked device 33 to maintain a fixed angle between the connecting seat 25 and the chassis 21. The chassis 21 always stays parallel to the connecting seat 25.

In a preferable embodiment of the invention, the linked device 33 comprises a linked rod 333, the spring device 335, a first connecting unit 331 and a second connecting unit 332. The spring device 335 is disposed on the linked rod 333. For example, the spring device 335 comprises a spring unit (coil-type spring) 3351, a first washer 3353, and a second washer 3355. The spring unit 3351 is sleeved onto the linked rod 333, and the two ends of the linked rod 333 are respectively provided with the first washer 3353 and the second washer 3355, such that the spring unit 3351 sleeved onto the linked rod 333 can be disposed between the first washer 3353 and the second washer 3355. In another embodiment of the invention, the first washer 3353 and the second washer 3355 can be omitted, and the spring unit 335 sleeved onto the linked rod 333 can be disposed between the first connecting unit 331 and the second connecting unit 332. As the support rod 23 rotates relative to the chassis 21 and/or the connecting seat 25, the spring device 335 can be compressed or extended, and the spring force of the spring unit is able to support the weight of the connecting seat 25 and/or the monitor borne on the connecting seat 25. For example, the spring device 335 is compressed or extended by the first washer 3353 lodged in the engagement unit 2317 and the second washer 3355.

In one embodiment of the invention, the support apparatus 201 only comprises the first U-type connecting unit 241 to connect the wing 211 of the chassis 21 and the first connecting part 2313 of the rod 23, as shown in FIG. 3A. In another embodiment of the invention, the support apparatus 203 only comprises the second U-type connecting unit 243 to connect the connecting piece 251 of the connecting seat 25 and the second connecting part 2315 of the rod 23, as shown in FIG. 3B.

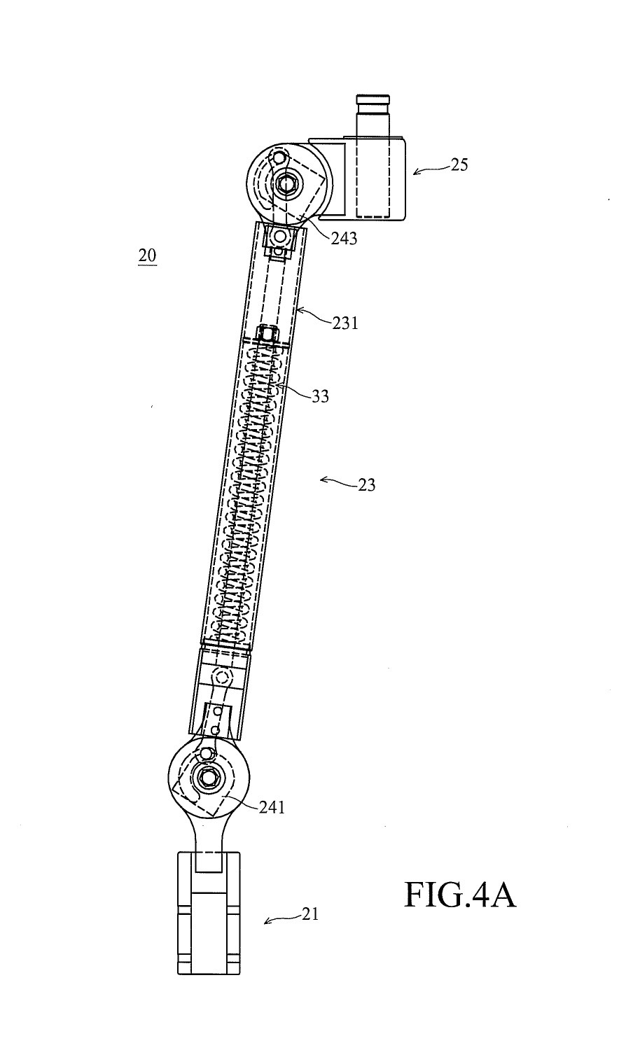

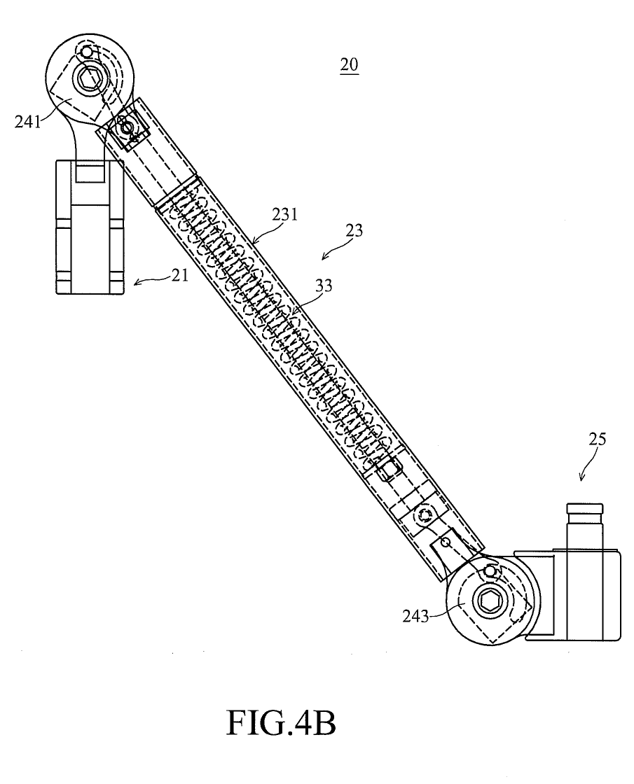

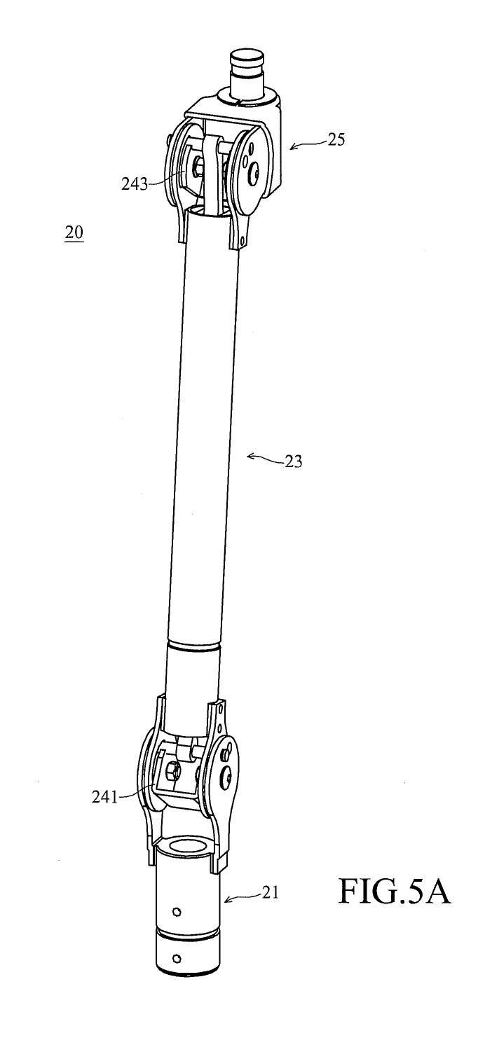

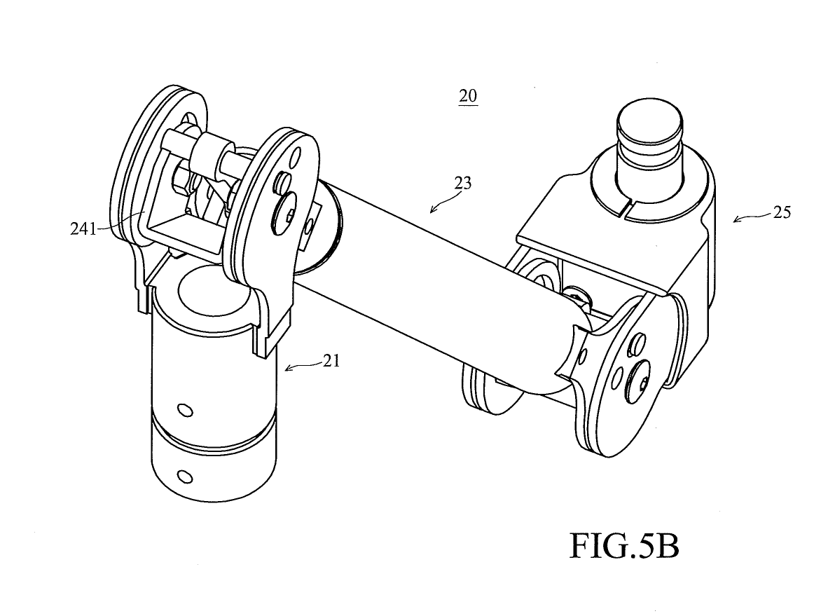

Referring to FIG. 4A, FIG. 4B, FIG. 5A and FIG. 5B, shown are perspective diagrams and structural diagrams of the support apparatus according to an embodiment of the present invention during operation. The support apparatus 20 comprises a chassis 21, a support rod 23, and a connecting seat 25. The two ends of the support rod 23 are respectively connected to the chassis 21 and the connecting seat 25, and the support rod 23 comprises a rod 231 and a linked device 33 disposed within the rod 231.

As a user lifts up the connecting seat 25, the connecting seat 25 and the chassis 21 push or pull each other via the linked device 33 to maintain a fixed angle between the connecting seat 25 and the chassis 21, as shown in FIG. 4A and FIG. 5A.

Alternatively, as the user pulls down the connecting seat 25, the connecting seat 25 and the chassis 21 push or pull each other via the linked device 33 to maintain a fixed angle between the connecting seat 25 and the chassis 21, as shown in FIG. 4B and FIG. 5B.

Instead of the axle bolt of the prior art, the first U-type connecting unit 241 is able to connect the chassis 21 to the rod 231, and the second U-type connecting unit 243 is able to connect the rod 231 and the connecting seat 25. Therefore, the axle bolts (1113/113/171/173) of the prior art will not interfere with the support rod 23, thus enabling an increase in the adjustable range and angle of the support rod 23 and the connecting seat 25.

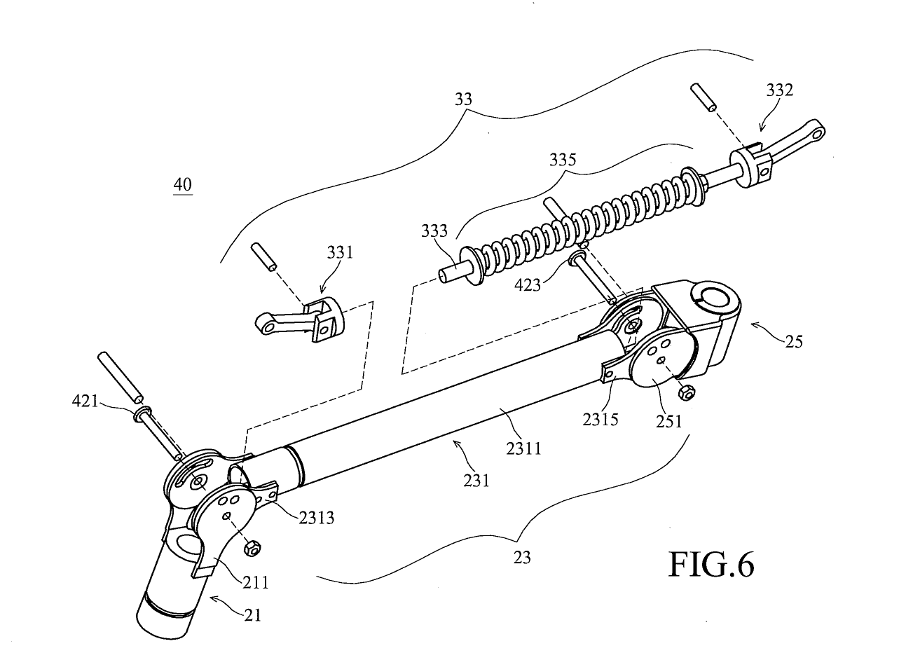

Referring to FIG. 6, shown is an exploded diagram of a support apparatus according to another embodiment of the present invention. The support apparatus 40 comprises a chassis 21, a support rod 23, and a connecting seat 25. The support rod 23 comprises a rod 231 and a linked device 33. The rod 231 comprises a hollow column 2311, and the two ends of the hollow column 2311 are respectively provided with a first connecting unit 331 and a second connecting unit 332.

The difference in structure between the support apparatus 40 and the support apparatus 20 of FIG. 3 is that the first connecting part 2313 connects with the wing 211 via a first axle bolt 421 in this embodiment. The support rod 23 forms a rotatable joint with the chassis 21 by way of the first axle bolt 421. Moreover, the second connecting part 2315 and the connecting piece 251 are connected to each other via a second axle bolt 423, and the support rod 23 forms a rotatable joint with the connecting seat 25 by way of the second axle bolt 423.

In this embodiment of the invention, the hollow column 231 is able to cover the linked device 33 to maintain the size of the support rod 23 during operation of the support apparatus 40, so as to avoid defects in the prior art, such as the user's fingers being clipped by the hang arm 13 and the connecting rod 15.

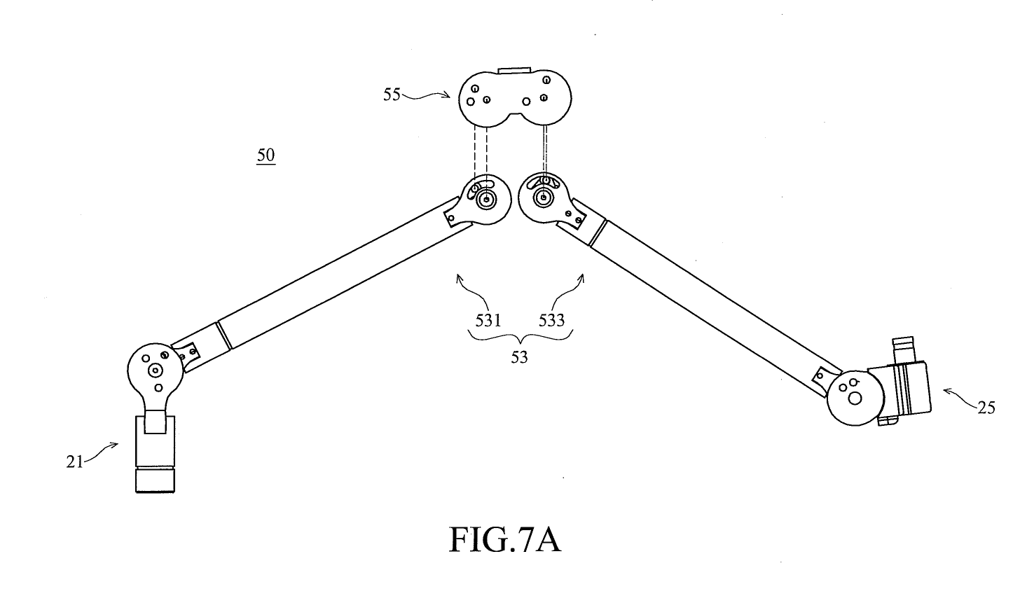

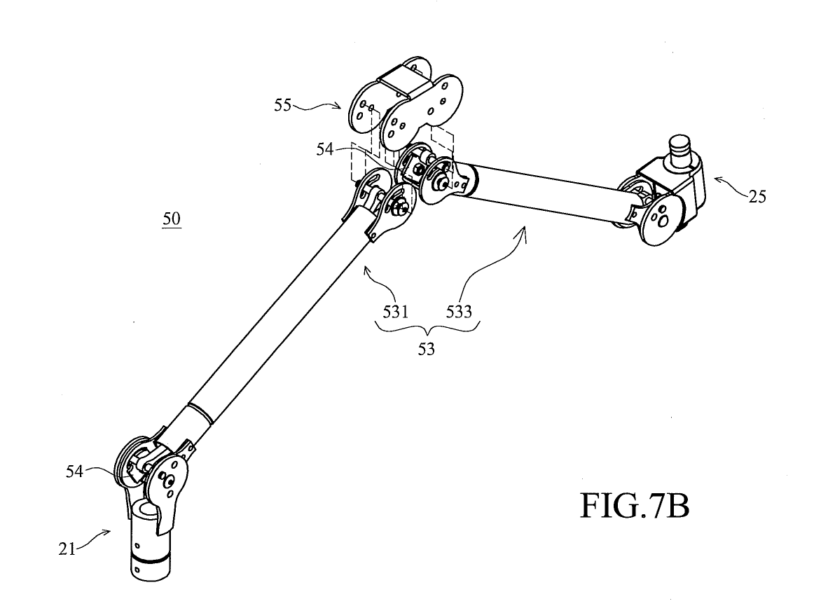

Referring to FIG. 7A and FIG. 7B, shown are structural diagrams of the support apparatus according to another embodiment of the present invention. The support apparatus 50 comprises a chassis 21, a plurality of support rods 53, and a connecting seat 25. In one embodiment of the invention, the support rods 53 comprise a first support rod 531 and a second support rod 533. Moreover, the structure of the first support rod 531 and the second support rod 533 are similar to the structure of the support rod 23, as shown in FIG. 3.

One end of the first support rod 531 is connected to the chassis 21, the other end of the first support rod 531 is connected to one end of the second support rod 533 via a connecting unit 55, and the other end of the second support rod 533 is connected to the connecting seat 25. In one embodiment of the invention, the first support rod 531 is respectively connected to the chassis 21 and the second support rod 533 via a U-type connecting unit 54, and the second support rod 533 is connected to the connecting seat 25 via another U-type connecting unit 54.

The above embodiments are only used to illustrate the present invention, and are not intended to limit the scope thereof. Many modifications of the above embodiments can be made without departing from the spirit of the present invention.

What is claimed is:

1. An adjustable support apparatus, comprising:
at least one support rod, comprising:
a rod comprising a hollow column, wherein the two ends of said hollow column are respectively provided with at least one first connecting part and at least one second connecting part; and
a linked device comprising a linked rod disposed inside said hollow column, wherein the two ends of said linked rod are respectively connected to a first connecting unit and a second connecting unit;
a chassis comprising at least one wing connected to said first connecting unit of said linked device, wherein said wing of said chassis is connected to said first connecting part of said rod via a first U-type connecting unit; and
a connecting seat comprising at least one connecting piece connected to said second connecting unit of said linked device, wherein said connecting piece of said connecting seat is connected to said second connecting part of said rod via a second U-type connecting unit.

2. The adjustable support apparatus of claim 1, wherein said first U-type connecting unit and said second U-type connecting unit both comprise a bottom plate and two side plates set on two opposite sides of said bottom plate.

3. The adjustable support apparatus of claim 2, comprising two first fixed units respectively disposed on said two side plates of said first U-type connecting unit to connect said first connecting part, said wing and said first U-type connecting unit, and two second fixed units respectively disposed on said two side plates of said second U-type connecting unit to connect said second connecting part, said connecting piece, and said second U-type connecting unit.

4. The adjustable support apparatus of claim 2, further comprising at least one first fillister positioned on said two side plates of said first U-type connecting unit, and at least one second fillister positioned on said two side plates of said second U-type connecting unit.

5. The adjustable support apparatus of claim 4, further comprising a first bolt connecting said first connecting unit, said first connecting part, and said chassis, and a second bolt connecting said second connecting unit, said second connecting part, and said connecting seat.

6. The adjustable support apparatus of claim 5, wherein said first bolt is retained within said first fillister, and said second bolt is retained within said second fillister.

7. The adjustable support apparatus of claim 6, further comprising a first arc slot positioned on said first connecting part for containing said first bolt, and a second arc slot positioned on said second connecting part for containing said second bolt.

8. The adjustable support apparatus of claim 3, wherein said chassis and said rod are able to rotate relative to said two first fixed units, and said rod and said connecting seat are able to rotate relative to said two second fixed units.

9. The adjustable support apparatus of claim 1, further comprising a spring device disposed on said linked rod.

10. The adjustable support apparatus of claim 9, wherein said spring device comprises a spring unit, a first washer, and a second washer, wherein said spring unit is sleeved onto said linked rod, the two ends of said rod are respectively connected to said first washer and said second washer, and said spring unit is disposed between said first washer and said second washer.

11. The adjustable support apparatus of claim 1, wherein said support rod comprises a first support rod and a second support rod.

12. The adjustable support apparatus of claim 11, further comprising a connecting unit for connecting said first support rod and said second support rod.

13. An adjustable support apparatus, comprising:
at least one support rod, comprising:
a rod comprising a hollow column, wherein the two ends of said hollow column are respectively provided with at least one first connecting part and at least one second connecting part; and
a linked device comprising a linked rod positioned within said hollow column, wherein the two ends of said linked rod are respectively connected to a first connecting unit and a second connecting unit;
a chassis comprising at least one wing connected to said first connecting unit of said linked device, wherein said wing of said chassis is connected to said first connecting part of said rod via a first axle bolt; and
a connecting seat comprising at least one connecting piece connected to said second connecting unit of said linked device, wherein said connecting piece of said connecting seat is connected to said second connecting part of said rod via a second axle bolt.

14. The adjustable support apparatus of claim 13, further comprising a first bolt connecting said first connecting unit, said first connecting part, and said chassis, and a second bolt connecting said second connecting unit, said second connecting part, and said connecting seat.

15. The adjustable support apparatus of claim 13, further comprising a spring device positioned on the linked rod.

16. The adjustable support apparatus of claim 15, wherein said spring device comprises a spring unit, a first washer, and a second washer, wherein said spring unit is sleeved onto said linked rod, the two ends of said rod are respectively connected to said first washer and said second washer, and said spring unit is disposed between said first washer and said second washer.

17. The adjustable support apparatus of claim 13, further comprising a first U-type connecting unit to connect said wing of said chassis and said first connecting part of said rod.

18. The adjustable support apparatus of claim 13, further comprising a second U-type connecting unit to connect said connecting piece of said connecting seat and said second connecting part of said rod.
